(19) United States
(12) Patent Application Publication
(10) Pub. No.: US 2022/0032292 A1
(43) Pub. Date: Feb. 3, 2022

(54) BIOCHIP STRUCTURE AND METHOD FOR MAKING SAME

(71) Applicant: SOCLE TECHNOLOGY CORP., Hsinchu (TW)

(72) Inventors: HSIANG-HUA LU, New Taipei (TW); CHING-YU NI, New Taipei (TW); YING-CHIEH PAN, New Taipei (TW)

(21) Appl. No.: 17/097,253

(22) Filed: Nov. 13, 2020

(30) Foreign Application Priority Data
Jul. 31, 2020 (CN) 202010761591.X

(51) Int. Cl. B01L 3/00

(52) U.S. Cl. CPC B01L 3/502715; B01L 2300/0819; B01L 3/502707

(57) ABSTRACT

A method for making a biochip structure, includes: providing a substrate and forming a plurality of biochips on a surface of the substrate; forming a carrier on a side of the substrate having the biochips, defining a plurality of through holes in the substrate from a side of the substrate away from the carrier; and filling conductive material in each of the through holes to connect one of the biochips. The carrier defines a plurality of openings. Each opening cooperates with substrate to form a micro-channel, and one of the biochips is exposed in the micro-channel.

### FIELD

The subject matter herein generally relates to a biochip structure and a method for making the biochip structure.

### BACKGROUND

A biochip utilizes principles of molecular biology, biochemistry, etc., combined with micro-electromechanical technology. A biochip has a glass or polymer substrate. A large number of biochemical tests can be performed on a small area of the biochip. The micro-channels of the biochip can be used for procedures such as mixing, transferring, or separating specimens. However, known methods for making biochips are complicated and expensive.

### BRIEF DESCRIPTION OF THE DRAWINGS

Implementations of the present technology will now be described, by way of embodiments only, with reference to the attached figures.

FIG. 1 is a flowchart of a method of making a biochip structure.

FIG. 2 is a cross-sectional view showing a step S1 in the method of making the biochip as disclosed in FIG. 1.

FIG. 3 is a cross-sectional view showing a step S2 in the method of making the biochip as disclosed in FIG. 1.

FIG. 4 is a cross-sectional view showing a step S3 in the method of making the biochip as disclosed in FIG. 1.

FIG. 5 is a cross-sectional view showing a step S4 in the method of making the biochip as disclosed in FIG. 1.

FIG. 6 is a cross-sectional view showing a step S5 in the method of making the biochip as disclosed in FIG. 1.

FIG. 7 is a cross-sectional view showing a step S6 in the method of making the biochip as disclosed in FIG. 1.

FIG. 8 is a cross-sectional view of a finished biochip structure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

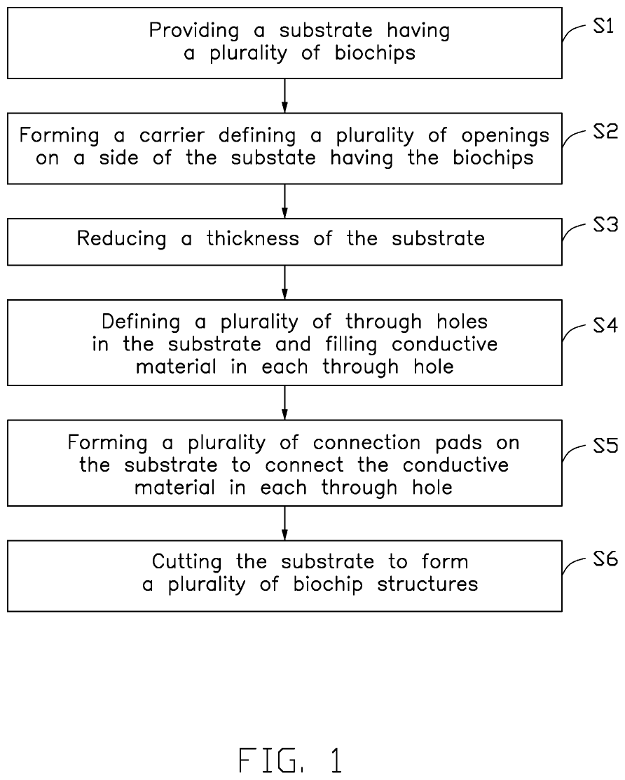

The present disclosure provides a method for making a biochip structure. As shown in FIG. 1, the method includes the following steps, the exemplary method can begin at step S1.

Step S1: providing a substrate having a plurality of biochips.

Step S2: forming a carrier defining a plurality of openings on a side of the substate having the biochips.

Step S3: reducing a thickness of the substrate.

Step S4: defining a plurality of through holes in the substrate and infilling each through hole with conductive material.

Step S5: forming a plurality of connection pads on the substrate for connecting to the conductive material.

Step S6: cutting the substrate to form a plurality of biochip structures.

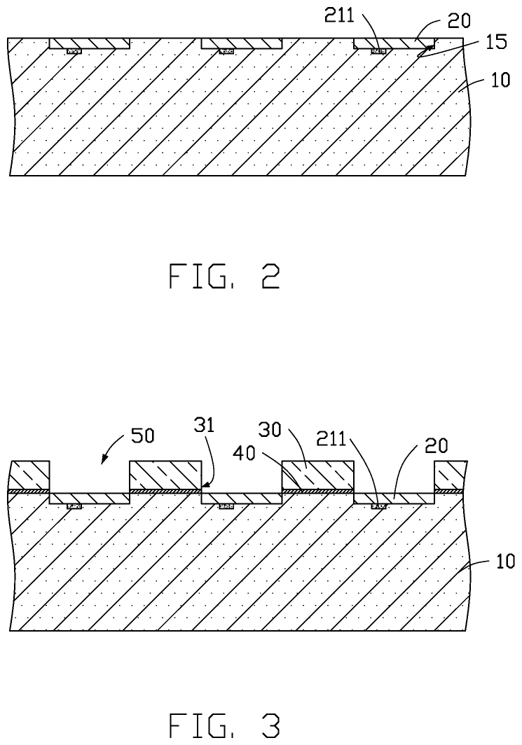

Refer to FIG. 2 for step S1 process. In this embodiment, the substrate 10 is a silicon substrate having a plurality of biochips 20. The biochips 20 are on a surface of the substrate 10 and spaced apart from each other. Each biochip 20 is designed to utilize principles of molecular biology, genetic information, analytical chemistry, etc., and cooperates with microelectromechanical automation or other precision processing technologies to achieve fast, accurate, and low-cost biological analysis and inspection capabilities. Each biochip 20 forms a sensing area exposed from the substrate 10. A side of the biochip 20 is provided with a conductive contact pad 211. The contact pad 211 is configured to allow external components (not shown) to electrically connect to the biochip 20.

Refer to FIG. 3 for step S2, showing that the carrier 30 is formed on a side of the substrate 10 having the biochips 20. The carrier 30 defines a plurality of openings 31 each extending through the carrier 30, and the openings 31 are spaced apart from each other. When the carrier 30 is positioned on the substrate 10, each opening 31 is at least partially aligned with one biochip 20, so that the biochip 20 is exposed from the opening 31. The wall of each opening 31 and the substrate 10 cooperative to form a micro-channel 50. The micro-channel 50 is used to accommodate biological specimens.

The carrier 30 can be made of glass, silicon, or the like. The carrier 30 and the substrate 10 can be fixed together by an adhesive 40 between the carrier 30 and the substrate 10.

Step S2 specifically includes:

providing a flat carrier 30;

defining a plurality of openings 31 in the carrier 30, each opening 31 extending through the carrier 30 and the openings 31 being spaced apart from each other;

coating an adhesive 40 on a surface of the carrier 30 with openings 31;

fixing the carrier 30 to the side of the substrate 10 having the biochips 20 by the adhesive 40, and each opening 31 being at least partially aligned with one biochip 20 so that each biochip 20 is exposed through the opening 31; and
curing the adhesive 40.

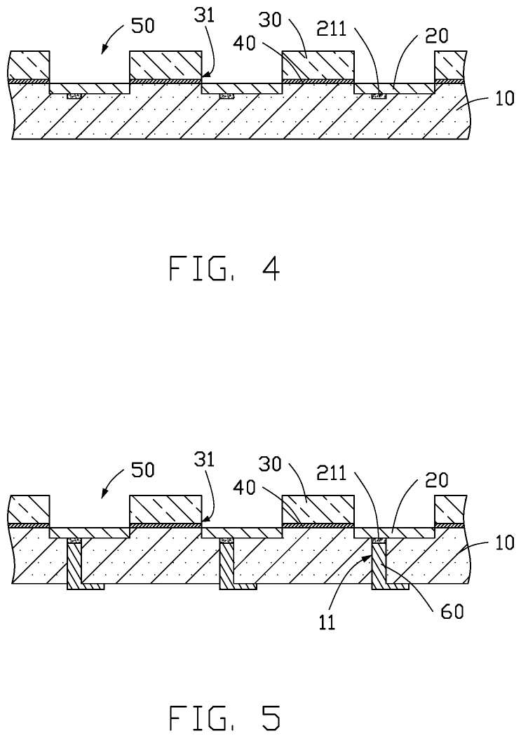

Referring to FIG. 4, Step S3 shows that the thickness of the substrate 10 is reduced from a side of the substrate 10 away from the biochips 20. The reduction in thickness can be done by mechanical grinding.

It is understandable that if the thickness of the substrate 10 in step S1 is already of the required thickness, step S3 can also be omitted. Since the thickness of the substrate 10 is usually more than 100 micrometers, the thickness of the substrate 10 can be reduced to less than 100 micrometers to facilitate subsequent step S4.

Referring to FIG. 5, Step S4 shows a plurality of through holes 11 defined in the substrate 10 from a side of the substrate 10 away from the biochips 20, and conductive material 60 infilling each through hole 11. The substrate 10 being thinned in the step S3 allows easier formation of the through hole 11 and infilling of the conductive material 60 in the step S4.

As shown in FIG. 5, each through hole 11 extends through the substrate 10 and is aligned with a contact pad 211 of a biochip 20. The conductive material 60 in the through hole 11 is connected to the contact pad 211 of the biochip 20. The conductive material 60 can be various conductive metals, conductive alloys, and the like. The conductive material 60 not only fills the through hole 11 but also extends to the bottommost surface of the substrate 10.

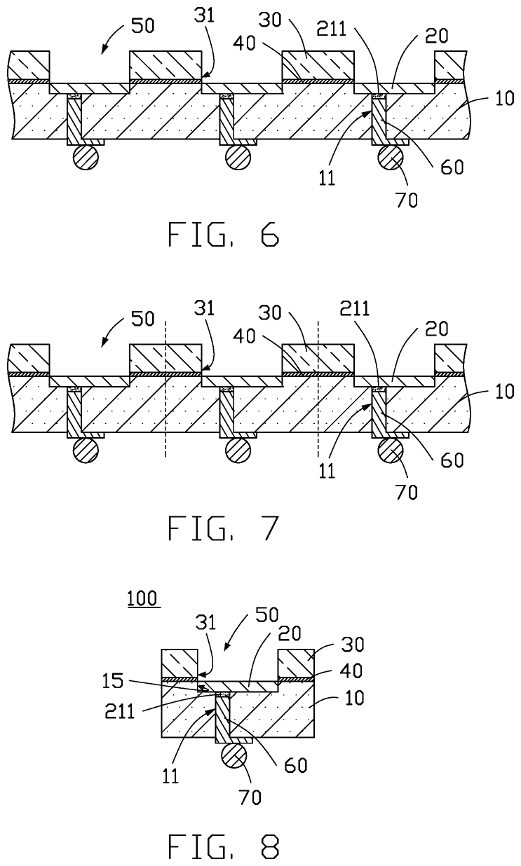

Referring to FIG. 6, Step S5 shows a plurality of connection pads 70 formed on the substrate 10 to connect to the conductive material 60 in the through holes 11. The connection pad 70 is located on a surface of the substrate 10 away from the carrier 30. In this embodiment, each connection pad 70 can be soldered, and can be formed by spot soldering. In other embodiments, the connection pad 70 may also be other conductive materials. The connection pad 70 creates an electrical connection between the biochip 20 and other components (not shown).

Referring to FIG. 7, Step S6 shows in section the substrate 10 and the carrier 30 cut to form a plurality of independent biochip structures 100. Each biochip structure 100 includes a biochip 20, a micro-channel 50, a through hole 11, and a connection pad 70 as shown in FIG. 8.

The method for making the biochip structure has a simple process and can realize preparation of multiple biochip structures at the same time. This method does not require wires to be connected to the biochip 20 on the surface of the substrate 10, but realizes electrical connections with the biochip 20 by the through hole 11 extending through the substrate 10, which simplifies the biochip structure. In addition, the carrier 30 cooperates with the substrate 10 to form micro-channels 50, avoiding common problems of liquid leakage from the micro-channels when formed by plastic injection molding.

As shown in FIG. 8, the biochip structure 100 includes a substrate 10 having a biochip 20 and a carrier 30 on a side of the substrate 10. The substrate 10 can be a silicon substrate having the biochip 20. The material of the carrier is not limited, and for example may be glass or silicon.

In the present embodiment, the substrate 10 defines a groove 15, the groove 15 receives the biochip 20. The biochip 20 in the groove 15 is flush with the surface of the substrate 10 defining the groove 15.

The carrier 30 defines an opening 31 extending through the carrier 30, and the opening 31 of the carrier 30 cooperates with the substrate 10 to form a micro-channel 50 for accommodating a biological specimen (not shown). The biochip 20 exposed from the substrate 10 form a sensing area, and the biochip 20 is exposed through the micro-channel 50 so as to be able to directly contact the biological specimen during detection. A conductive contact pad 211 is formed on an inner side the biochip 20, the substrate 10 defines a through hole 11 aligning with the contact pad 211, and conductive material 60 is provided in the through hole 11 to electrically connect to the contact pad 211. A conductive connection pad 70 is further provided on a side of the substrate 10 away from the carrier 30, and the connection pad 70 is connected to the conductive material 60 in the through hole 11. The biochip 20 sequentially relies on the contact pad 211, the conductive material 60 in the through hole 11, and the connection pad 70, for electrical connectivity to external components (not shown).

For the biochip structure 100 in the present disclosure no additional wires are required on the substrate 10 to realize electrical connection between the biochip 20 and other external components.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

What is claimed is:

1. A method for making a biochip structure, comprising:
providing a substrate having a plurality of biochips on a surface of the substrate;
forming a carrier on a side of the substrate having the plurality of biochips, the carrier defining a plurality of openings, each of the plurality of openings cooperating with substrate to form a micro-channel, one of the plurality of biochips being exposed from the micro-channel;
defining a plurality of through holes in the substrate from a side of the substrate away from the carrier; and
filling conductive material in each of the plurality of through holes to connect one of the plurality of biochips.

2. The method of claim 1, further comprising forming a plurality of connection pads on the substrate, wherein each of the plurality of connection pads is electrically coupled to the conductive material in one of the plurality of through holes.

3. The method of claim 1, further comprising reducing a thickness of the substrate from a side of the substrate away from the carrier before defining the plurality of through holes in the substrate.

4. The method of claim 3, wherein the thickness of the substrate is reduced to be less than 100 micrometers.

5. The method of claim 1, further comprising cutting the substrate to form a plurality of biochip structures, wherein each of the plurality of biochip structures comprises one of the plurality of biochip, one of the plurality of micro-channels, and one of the plurality of through holes.

6. The method of claim 1, wherein forming the carrier on the substrate comprises:
providing a flat carrier;
defining a plurality of openings in the carrier, each of the plurality of openings extending through the carrier;
coating an adhesive on a surface of the carrier with the plurality of openings;
adhering the carrier to the side of the substrate having the plurality of biochips by the adhesive, and each of the plurality of openings being at least partially aligned with one of the plurality of biochips; and
curing the adhesive.

7. The method of claim 1, wherein forming the plurality of biochips on a surface of the substrate comprises defining a plurality of grooves in the surface of the substrate and each of the plurality of grooves accommodating one of the plurality of biochips.

8. The method of claim 1, wherein a contact pad is between each of the plurality of biochips and the substrate.

9. A biochip structure, comprising:
a substrate having a biochip, the substrate defining a through hole, the through hole being filled in with conductive material to connect the biochip; and
a carrier on a side of the substrate having the biochip, the carrier defining an opening extending through the carrier, the opening cooperating with the substrate to form a micro-channel, the biochip being exposed from the micro-channel.

10. The biochip structure of claim 9, wherein the biochip exposed from the substrate forms a sensing area; the sensing area is exposed in the micro-channel.

11. The biochip structure of claim 9, further comprising a contact pad on a side of the biochip, the contact pad being aligned with the through hole and electrically coupled to the conductive material in the through hole.

12. The biochip structure of claim 9, further comprising a connection pad is on a side of the substrate away from the carrier, the connection pad being electrically coupled to the conductive material in the through hole.

13. The biochip structure of claim 9, wherein the substate is a silicon substrate having the biochip.

14. The biochip structure of claim 9, wherein the carrier is made of silicon or glass.
